(19) United States
(12) Patent Application Publication
(10) Pub. No.: US 2025/0030716 A1
(43) Pub. Date: Jan. 23, 2025

(54) THREAT REGISTRY AND ASSESSMENT

(71) Applicant: Wells Fargo Bank, N.A., San Francisco, CA (US)

(72) Inventors: Shane Dale Cross, Morganton, NC (US); Peter Anatole Makohon, Huntersville, NC (US); Christopher Schooley, Colorado Springs, CO (US); Shawn Wallis, Fremont, CA (US); Robert Irving Kirby, JR., Charlotte, NC (US); Jae Wook Lee, Charlotte, NC (US)

(21) Appl. No.: 17/194,768

(22) Filed: Mar. 8, 2021

(51) Int. Cl. H04L 29/06

(52) U.S. Cl. CPC H04L 63/1433; H04L 63/1408; H04L 63/1441; H04L 63/20

(57) ABSTRACT

Techniques described herein pertain to prioritizing threats based on their potential effect on the specific enterprise network sought to be protected. In one example, this disclosure describes a method that includes collecting, by a computing system and from a plurality of external data sources, threat information; storing, by the computing system and in a threat registry, the threat information that includes information about a plurality of threats; collecting, by the computing system, information about an attack surface for an enterprise network; mapping, by the computing system, the threat information to the attack surface; analyzing, by the computing system and based on the mapping of the threat information to the attack surface, a threat included in the plurality of threats to identify a risk score associated with the threat, wherein the risk score represents an assessment of the vulnerability of the enterprise network to the threat.

### TECHNICAL FIELD

This disclosure relates to computer networks, and more specifically, to assessing threats to a network.

### BACKGROUND

Computer networks, and enterprise networks in particular, face a continually-evolving set of threats. An attacker may have any of an array of strategic goals, ranging from stealing information, to extorting ransom, to destroying an organization's information technology infrastructure, and beyond. To achieve such goals, however, attackers complete a series of incremental steps.

Network defenders can benefit from knowledge of the tactics, techniques and procedures that adversaries use to execute these steps to gain access and execute their objectives. An understanding of how to best prioritize available network defenses can help counter an attacker's actions. If a network defender can stop or slow an attacker's progression toward its goal, the attacker may be able to prevent or at least mitigate the effects of attacker's efforts.

### SUMMARY

This disclosure describes techniques that include managing a dynamic portfolio of threats to an enterprise network. In some examples, such techniques involve prioritizing threats based on their potential effect on the specific enterprise network sought to be protected. Such techniques may enable identification of high-risk threat targets and use of predictive modeling to forecast outcomes based on a range of actions intended to mitigate risk.

As described herein, a computing system may develop, collect, and/or manage a structured and normalized set of data describing attack vectors and compensating controls. The structured and normalized set of data, which may be in the form of a threat registry, may enable proactive and automated threat modeling and assessment. To effectively use such a threat registry, a computing system may discover, enumerate, and profile enterprise network assets that comprise an attack surface for an enterprise network. The computing system may also deploy data collection agents to assist with threat detection, risk assessment and threat modeling. Such threat modeling may enable effective assessments of polices, controls, and imperatives that apply to the network, and as a result, identify any vulnerabilities of the network. Threats may be ranked based on a risk score, representing relative risk present in the environment.

The techniques described herein may provide certain technical advantages. For instance, a registry of threat information may enable assessments to be performed in an automated way, without significant manual efforts and/or adjustments. Such automation may enable assessments to be performed frequently and refreshed often so that when a threat is modeled, risk evaluations can tracked over time and observations about how such risk evaluations are changing can be evaluated. By refreshing risk assessments often, models representing the current vulnerability of an enterprise network are more likely to be accurate, and less likely to be representative of threats that have since been deprioritized or that no longer apply.

In some examples, this disclosure describes operations performed by a computing system that interacts with and/or manages an enterprise network in accordance with one or more aspects of this disclosure. In one specific example, this disclosure describes a method comprising collecting, by a computing system and from a plurality of data sources, threat information about a plurality of threats; storing, by the computing system and in a threat registry, the threat information; collecting, by the computing system, information about an attack surface for an enterprise network; mapping, by the computing system, the threat information to the attack surface; and proactively calculating, by the computing system and based on the mapping of the threat information to the attack surface, a risk score associated with a specific threat in the plurality of threats, wherein the risk score represents an assessment of the vulnerability of the enterprise network to the specific threat.

In another example, this disclosure describes a system comprising a storage system and processing circuitry having access to the storage system and configured to: collect threat information about a plurality of threats, store, in a threat registry, the threat information, collect information about an attack surface for an enterprise network, map the threat information to the attack surface, and proactively calculate, based on the mapping of the threat information to the attack surface, a risk score associated with a specific threat in the plurality of threats, wherein the risk score represents an assessment of the vulnerability of the enterprise network to the specific threat.

In another example, this disclosure describes a computer-readable storage medium comprising instructions that, when executed, configure processing circuitry of a computing system to collect threat information about a plurality of threats; store, in a threat registry, the threat information; collect information about an attack surface for an enterprise network; map the threat information to the attack surface; and proactively calculate, based on the mapping of the threat information to the attack surface, a risk score associated with a specific threat in the plurality of threats, wherein the risk score represents an assessment of the vulnerability of the enterprise network to the specific threat.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1A is a conceptual diagram illustrating an example system in which threats to an example enterprise network may be analyzed and assessed, in accordance with one or more aspects of the present disclosure.

FIG. 1B is a conceptual diagram illustrating operations performed by an example threat management system, in accordance with one or more aspects of the present disclosure.

FIG. 2 is a block diagram illustrating an example system in which threats to an example enterprise network may be analyzed and assessed, in accordance with one or more aspects of the present disclosure.

FIG. 3A, FIG. 3B, and FIG. 3C are conceptual diagrams illustrating example user interfaces presented by a user interface device in accordance with one or more aspects of the present disclosure.

FIG. 4 is a flow diagram illustrating operations performed by an example threat management system in accordance with one or more aspects of the present disclosure.

### DETAILED DESCRIPTION

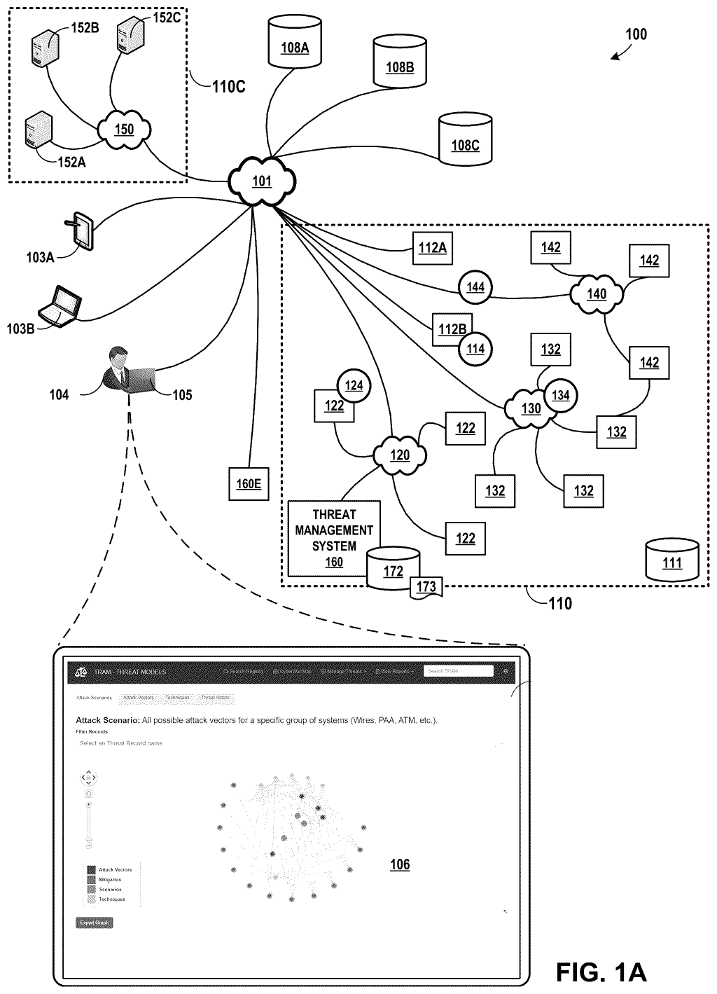

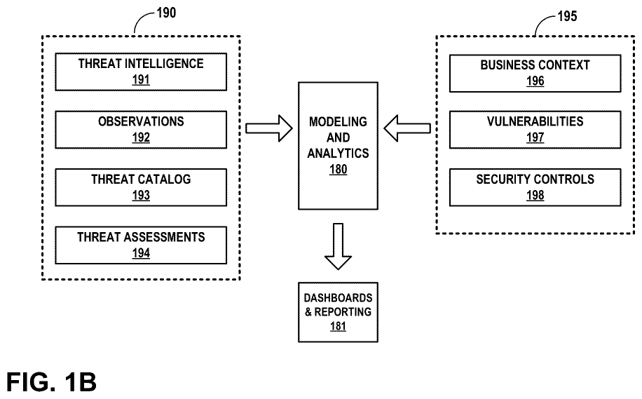

FIG. 1A is a conceptual diagram illustrating an example system 100 in which threats to an example enterprise network may be analyzed and assessed, in accordance with one or more aspects of the present disclosure. In FIG. 1A, system 100 illustrates enterprise network 110 in communication, via network 101, with a number of systems and/or devices. Such systems and/or devices include device 103A and device 103B (collectively “devices 103” and representing any number of device), administrator device 105 (operated by administrator 104), and external data source 108A through external data source 108C (collectively “external data sources 108” and representing any number of external data sources). Network 101 may be implemented, in various examples, by any appropriate public or private network. In some examples, network 101 may correspond to the internet.

Devices 103 may represent user devices, external to enterprise network 110, that interact with enterprise network 110 over network 101. In some examples, one or more of devices 103 may be operated by a user, such as an employee of the enterprise associated with enterprise network 110. In such an example, such a user may possess authentication credentials enabling access to certain services provided by enterprise network 110. In another example, one or more devices 103 may be operated by a customer or other user, with perhaps less authentication credentials to access services or resources of enterprise network 110. In some examples, one or more of devices 103 may be operated by an adversary seeking to gain unauthorized access to resources provided by enterprise network 110.

Each of external data sources 108 may represent a system that publishes or otherwise makes available information about potential tactics, techniques, and/or procedures known to be employed by adversaries (e.g., those seeking to gain unauthorized access to enterprise network 110). In some examples, one or more of external data sources 108 may be computing systems that publish information about the MITRE ATT&CK open framework and knowledge base of security threat tactics and techniques. MITRE ATT&CK™ is a globally-accessible knowledge base of adversary tactics and techniques based on real-world observations, with defined mitigations and associated data sources for each threat. The ATT&CK knowledge base can be used as a foundation for the development of specific threat models and methodologies in the private sector, in government, and in the cybersecurity product and service community. Such a CK knowledge base may provide a common taxonomy of the tactical objectives of adversaries that may seek to breach the security of enterprise network 110 and the methods that may be employed.

Alternatively, or in addition, one or more of external data sources 108 may be computing systems having information based on the National Vulnerability Database (NVD) developed by the National Institute of Standards and Technology (NIST). NIST develops and maintains an extensive collection of standards, guidelines, recommendations, and research on the security and privacy of information and information systems. The NVD includes security checklist references, security related software flaws, misconfigurations, product names, and impact metrics, and may serve as a robust framework for enumerating and tracking cyber security controls. In particular, the NVD provides control framework hierarchy that can be used for enumerating and tracking cyber security controls. In some examples, such a framework may allow for multiple layers of assignment, assessment and reporting, and can be used as a baseline for audits and assessments of security controls deployed within enterprise network 110.

In the example of FIG. 1A, enterprise network 110 is illustrated as including a number of networks, including network 120, network 130, and network 140. Each of such networks includes one or more connected enterprise systems. For example, network 120 connects a number of enterprise systems 122, network 130 connects a number of enterprise systems 132, and network 140 connects a number of enterprise systems 142. In addition, one or more other computing systems within network 101 may be directly connected to network 101, and may operate as public-facing systems (see, e.g., public-facing computing system 112A and public-facing computing system 112B.

Systems within enterprise network 110 may store a record of their activity in enterprise network log 111. Enterprise network log 111 thus serves as a running log of various operations performed by enterprise network 110. Many systems within enterprise network 110 may have write access to enterprise network log 111 enabling such devices to store records reflecting activity on enterprise network 110. Some of such systems may also have read access to enterprise network log 111, enabling analysis of historical operations performed by enterprise network 110.

In some examples, various aspects of enterprise network 110 may be implemented using computing infrastructure made available by a cloud services provider. Such aspects or portions of enterprise network 110 are illustrated in FIG. 1A as enterprise network 110C (where “C” represents a “Cloud” system). In the example of FIG. 1A, enterprise network 110C is illustrated as a relatively small portion of enterprise network 110. In other examples, however, enterprise network 110C may represent a substantial portion of enterprise network 110. In still other examples, enterprise network 110 may be entirely implemented through a cloud-based computing infrastructure.

In general, although enterprise network 110 is illustrated herein as a relatively well-defined network, in practice, enterprise network 110 may span a substantial geographic region across numerous countries. Accordingly, enterprise network 110 may connect locations and offices throughout the world. Enterprise network 110 may be of such scale that it could include hundreds of thousands of endpoints, and possibly thousands of subnets. Accordingly, systems described herein as operating within enterprise network 110 may span multiple geographic regions and multiple systems and networks.

One or more security controls (e.g., security control 114, security control 124, security control 134, security control 144) may be deployed within enterprise network 110, and such security controls can take any of a variety of forms. For example, security controls may include network devices, firewalls, software, network processes and/or policies, logs (e.g., active directory logs, firewall logs, malware detection logs, email logs, proxy logs). Generally, security controls may be either passive controls or enforcement controls used as attack defense mechanisms. Some controls may also be used in the context of automated threat modeling and assessment. Security controls are typically detectable through automated discovery, and can be monitored for effectiveness. Different controls may be used for monitoring, compensating for, or addressing different types of threats.

In the example illustrated in FIG. 1A, various security controls are illustrated as deployed within enterprise network 110. For instance, some of the controls illustrated may represent software executing on one or more of enterprise systems 122 (e.g., security control 124). Other controls include a network device on network 130 (e.g., security control 134), a firewall protecting network 140 (security control 144), and an authentication policy or procedure for public-facing computing system 112B (e.g., security control 114). For ease of illustration, only a small number of such security controls are shown in FIG. 1A, but many more may be present.

Threat management system 160 may be implemented as any suitable computing system, such as one or more server computers, workstations, appliances, cloud computing systems, and/or other computing systems that may be capable of performing operations and/or functions described in accordance with one or more aspects of the present disclosure. In some examples, aspects of threat management system 160 may be implemented through a cloud computing system, server farm, and/or server cluster (or portion thereof). In other examples, threat management system 160 may represent or be implemented through one or more virtualized compute instances (e.g., virtual machines, containers) of a data center, cloud computing system, server farm, and/or server cluster. Although illustrated and described primarily as a single system, threat management system 160 may encompass multiple computing systems.

Threat management system 160 may be part of enterprise network 110 and may perform a number operations to assess, evaluate, and manage threats to enterprise network 110, as further described herein. Threat management system 160 may be connected to one or more of the networks that make up enterprise network 110. In the example of FIG. 1A, for example, threat management system 160 is shown connected to network 120, although threat management system 160 may be connected to additional networks within enterprise network 110. Threat management system 160 includes registry 172 and manages, uses, and processes the information stored within registry 172 (e.g., threat information 173).

In some examples, threat management system 160 may perform assessments of enterprise network 110 that involve simulating externally generated network activity (e.g., an attack by an intruder) or evaluating responses to such network activity. Accordingly, such an assessment or simulation may be appropriately initiated by a device outside of enterprise network 110. In such an example, as well as others, aspects of threat management system 160 may therefore be implemented outside of enterprise network 110. Threat management system 160E (where “E” represents an “External” system) is illustrated in FIG. 1A to represent those aspects of threat management system 160 that may operate outside of or distinct from enterprise network 110.

Administrator device 105 may represent a device operated by administrator 104. In some examples, administrator device 105 may, at the direction of administrator 104, interact with threat management system 160. Based on such interactions, administrator device 105 may present information (e.g., in the form of user interface 106) at a display associated with administrator device 105.

In accordance with one or more aspects of the present disclosure, threat management system 160 may collect attack surface information associated with enterprise network 110. For instance, in an example that can be described in the context of FIG. 1A, threat management system 160 interacts with systems, subsystems, application systems, devices, and other elements of enterprise network 110 to collect information about the structure and operation of enterprise network 110. In some examples, threat management system 160 may ingest information from a configuration management database maintained within enterprise network 110. As part of such a process, threat management system 160 may perform (or cause other systems to perform) network discovery operations that enable threat management system 160 to enumerate and profile information about assets, systems, network structure, and other information about enterprise network 110.

Threat management system 160 may collect threat source information. For instance, continuing with the example being described in the context of FIG. 1A, threat management system 160 interacts with a number of external data sources 108 to identify, research, and acquire information about threats that affect networks generally and enterprise network 110 specifically. In some examples, threat management system 160 may collect information associated with privately or publicly maintained security frameworks (e.g., the MITRE ATT&ACK framework). Threat management system 160 stores the information derived from external data sources 108 within registry 172 maintained by threat management system 160. As maintained by threat management system 160, registry 172 includes information about a number of instances of threat information 173.

Threat management system 160 may map the threat source information to the attack surface of enterprise network 110. For instance, again referring to FIG. 1A, threat management system 160 translates the information stored in registry 172 into a form that pertains specifically to enterprise network 110. In some examples, controls and mitigations prescribed by a security framework might apply to one network differently than another network. Accordingly, threat management system 160 uses the information it has collected about the attack surface for enterprise network 110 to translate information stored within registry 172 into information that pertains specifically to enterprise network 110. Such translations may result in the creation of various instances of threat information 173, each describing a different potential threat that could apply to enterprise network 110. In some examples, each instance of threat information 173 describes a specific threat and tactics and techniques that it may encompass. Each instance of threat information 173 may also identify specific controls, countermeasures, and practices that should be in place within enterprise network 110 in order to effectively counter the threat represented by each respective threat information 173.

Threat management system 160 may proactively assess to what extent the attack surface of enterprise network 110 is vulnerable to an array of threats identified by the threat source information. For instance, again referring to FIG. 1A, threat management system 160 accesses registry 172 and obtains information about a number threats that may pertain to enterprise network 110. Threat management system 160 evaluates, for each such threat included within registry 172, the existence of the controls, countermeasures, and practices that each respective instance of threat information 173 indicates should be in place to counter the threat. Threat management system 160 not only assesses whether such countermeasures are in place, threat management system 160 further assesses the effectiveness of such countermeasure (e.g., the effectiveness of such controls).

Threat management system 160 may generate a risk score for each of the evaluated threats. For instance, referring again to FIG. 1A, threat management system 160 determines, based on the existence and the assessed effectiveness of the countermeasures in place within enterprise network 110, a risk score for each of the evaluated threats. Threats against which enterprise network 110 is well protected may be assigned a lower risk score. Threats where enterprise network 110 lacks significant countermeasures may be assigned a higher risk score. In calculating risk scores for each threat (i.e., each instance of threat information 173), threat management system 160 may also consider the business and/or financial value of the systems within enterprise network 110 that the threat pertains to, and increase the risk score for those threats that involve high value business or financial targets. Threat management system 160 may also consider the extent to which the affected systems within enterprise network 110 are connected to other systems, and increase the risk score if those other connected systems have vulnerabilities and/or are high-value business or financial systems.

Threat management system 160 may report information about calculated risk scores. For instance, referring once again to the example being described in the context of FIG. 1A, threat management system 160 may output information about calculated risk scores over network 101. Administrator device 105, which may be operated by administrator 104 (or a risk manager), detects a signal over network 101. Administrator device 105 determines that the signal includes information sufficient to present a user interface. Administrator device 105 presents user interface 106 at a display associated with administrator device 105. Such a user interface may present information about assessments made by threat management system 160 about a given threat, and such information may include one or more calculated risk scores.

FIG. 1B is a conceptual diagram illustrating operations performed by an example threat management system, in accordance with one or more aspects of the present disclosure. In FIG. 1B, modeling and analytics module 180 may correspond to operations performed by threat management system 160 of FIG. 1A or by modules or subsystems included within threat management system 160. Modeling and analytics module 180 processes input in the form of both threat source information 190 and attack surface information 195. Based on such input, modeling and analytics module 180 generates output 181.

Threat source information 190 may generally represent information about prospective or potential attacks on enterprise network 110 collected as the result of research, observation, testing, and creative efforts (e.g., attack strategies developed by team working on behalf of an enterprise). Accordingly, threat source information 190 includes threat intelligence information 191, observations 192, threat catalog information 193, and threat assessments 194.

Attack surface information 195 may generally represent information about how a threat will be assessed relative to the attack surface (e.g., associated with enterprise network 110 of FIG. 1A). As such, attack surface information 195 includes information about vulnerabilities information 197 and security controls information 198 that may be in place on enterprise network 110. Attack surface information 195 may also include business context information 196. Such business context information 196 may include information about the value (e.g., financial value of or business value) of the aspects of enterprise network 110 targeted by the attack, and the extent to which such an attack might lead to exposure of other high-value aspects of enterprise network 110.

Modeling and analytics module 180 processes both threat source information 190 and attack surface information 195 to generate output 181. Output 181 may be in any of a variety of forms, including dashboards, alerts, reports, user interfaces (e.g., presented to administrator 104 by administrator device 105), or other forms. Modeling and analytics module 180 may occasionally, periodically, or continually perform additional modeling and analytics operations, thereby proactively producing a stream of output 181, which may enable not only threat assessments, but also how such threats to enterprise network 110 are changing over time.

The techniques described herein may provide certain technical advantages. For instance, operations performed by threat management system 160, as described herein, may result in improved prioritization of alerts (e.g., by severity), which may result in more effective responses to such alerts. Threat management system 160 may also provide better context to security operations when triaging alerts, for hunting operations and reporting up to management. Operations performed by threat management system 160 may enable defensive maneuvering to reduce response time to alerts by providing additional context to be included with alerts; such additional context may result in support teams having additional time for hunting operations. Where threat management system 160 has effective and accurate awareness of the attack surface of enterprise network 110, along with knowledge of control coverage and effectiveness, cyber threat detection capabilities may be enhanced. Threat management system 160, as described herein, may correlate risk, security controls, and threat actors to monitor and review risks and threats, and thereby improve prioritization and proactive responses to support teams. Techniques described herein may result in platform simplification and a normalized view of threat data from disparate sources. For some organizations, such techniques may improve the organization's position over customer security and may ultimately more effectively protect customers' information.

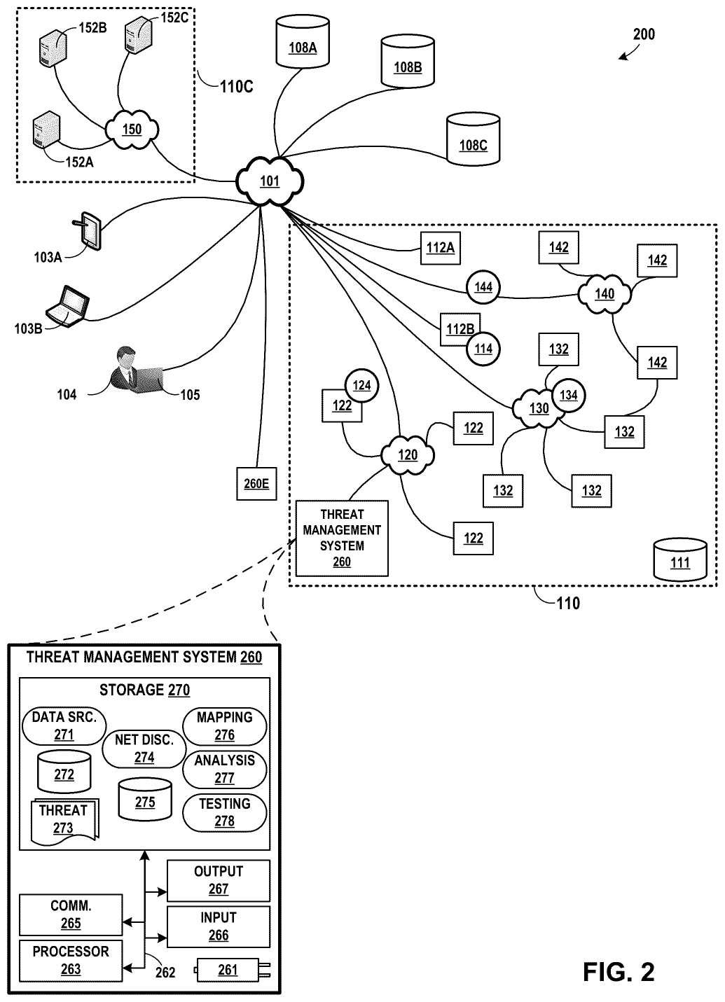

FIG. 2 is a block diagram illustrating an example system in which threats to an example enterprise network may be analyzed and assessed, in accordance with one or more aspects of the present disclosure. System 200 of FIG. 2 may be described as an example or alternative implementation of system 100 of FIG. 1A. Network 101, devices 103, administrator device 105, external data sources 108, enterprise network 110, enterprise network 110C, and others may each correspond to like-numbered elements of FIG. 1A. Such devices, systems, and/or components may be implemented in a manner consistent with the description of the corresponding system provided in connection with FIG. 1A, although in some examples such systems may involve alternative implementations with more, fewer, and/or different capabilities. In general, systems, devices, components, user interface elements, and other items in illustrated herein may correspond to like-numbered systems, devices, components, and items elsewhere illustrated herein, and may be described in a manner consistent with the description provided in connection with such other illustrations.

In FIG. 2, threat management system 260 may be considered a more detailed illustration of threat management system 160 of FIG. 1A, and may represent an example implementation of threat management system 160 of FIG. 1A. Threat management system 260E, also shown illustrated in FIG. 2, may operate in a manner similar to threat management system 160E described in connection with FIG. 1A, and may perform operations that are initiated outside of enterprise network 110 (e.g., a simulated attack). Threat management system 260 (and threat management system 260E) may represent any appropriate computing system, such as a physical computing device or compute node that provides an execution environment for various computing operations described herein. Although illustrated as a single computing system, threat management system 260 may correspond to a cluster of computing devices, compute nodes, workstations, or other computing resources. In some examples, threat management system 260 may represent one or more components of a cloud computing system, server farm, and/or server cluster (or portion thereof) that provide services to client devices and other devices or systems. Threat management system 260 may, in some examples, be implemented as one or more virtualized computing devices (e.g., as a collection of virtual machines or containers).

In the example of FIG. 2, threat management system 260 includes underlying physical compute hardware that includes power source 261, one or more processors 263, one or more communication units 265, one or more input devices 266, one or more output devices 267, and one or more storage devices 270. One or more of the devices, modules, storage areas, or other components of threat management system 260 may be interconnected to enable inter-component communications (physically, communicatively, and/or operatively). In some examples, such connectivity may be provided by through communication channels, which may include a system bus (e.g., bus 262), a network connection, an inter-process communication data structure, or any other method for communicating data.

Power source 261 of threat management system 260 may provide power to one or more components of threat management system 260. One or more processors 263 of threat management system 260 may implement functionality and/or execute instructions associated with threat management system 260 or associated with one or more modules illustrated herein and/or described below. One or more processors 263 may be, may be part of, and/or may include processing circuitry that performs operations in accordance with one or more aspects of the present disclosure. One or more communication units 265 of threat management system 260 may communicate with devices external to threat management system 260 by transmitting and/or receiving data, and may operate, in some respects, as both an input device and an output device. In some or all cases, communication unit 265 may communicate with other devices over network 101 or over other networks.

One or more input devices 266 may represent any input devices of threat management system 260 not otherwise separately described herein. One or more input devices 266 may generate, receive, and/or process input from any type of device capable of detecting input from a human or machine. For example, one or more input devices 266 may generate, receive, and/or process input in the form of electrical, physical, audio, image, and/or visual input (e.g., peripheral device, keyboard, microphone, camera).

One or more output devices 267 may represent any output devices of threat management system 260 not otherwise separately described herein. One or more output devices 267 may generate, receive, and/or process output from any type of device capable of outputting information to a human or machine. For example, one or more output devices 267 may generate, receive, and/or process output in the form of electrical and/or physical output (e.g., peripheral device, actuator).

One or more storage devices 270 within threat management system 260 may store information for processing during operation of threat management system 260. Storage devices 270 may store program instructions and/or data associated with one or more of the modules described in accordance with one or more aspects of this disclosure. One or more processors 263 and one or more storage devices 270 may provide an operating environment or platform for such modules, which may be implemented as software, but may in some examples include any combination of hardware, firmware, and software. One or more processors 263 may execute instructions and one or more storage devices 270 may store instructions and/or data of one or more modules. The combination of processors 263 and storage devices 270 may retrieve, store, and/or execute the instructions and/or data of one or more applications, modules, or software. Processors 263 and/or storage devices 270 may also be operably coupled to one or more other software and/or hardware components, including, but not limited to, one or more of the components of threat management system 260 and/or one or more devices or systems illustrated as being connected to threat management system 260.

Data sources module 271 may perform functions relating to collecting, analyzing, and storing data pertaining to threats. Data sources module 271 may interact with one or more external data sources 108 to research and/or collect information about known threats. Data sources modules 271 may correlate information from multiple different external data sources 108, and store such information in threat registry 272 to enable access and retrieval of information by topic or subject across multiple data sources.

Threat registry 272 may represent any suitable data structure or storage medium for storing information related to threats to enterprise network 110, including one or more instances of threat information 273. The information stored in threat registry 272 may be searchable and/or categorized such that one or more modules within threat management system 260 may provide an input requesting information from threat registry 272, and in response to the input, receive information stored within threat registry 272. Threat registry 272 may be primarily maintained by data sources module 271.

Network discovery module 274 may perform functions relating to collecting information about enterprise network 110, and may interact with systems, subsystems, controls, application systems, devices, and other elements of enterprise network 110 to collect information about the structure and operation of enterprise network 110. In some examples, network discovery module 274 may ingest information from a configuration management database maintained within enterprise network 110. As part of such a process, network discovery module 274 may perform (or cause other systems to perform) network discovery operations that enable threat management system 260 to enumerate and profile information about assets, systems, network structure, and other information.

Mapping module 276 may perform functions relating to mapping threats maintained within threat registry 272 or elsewhere to the attack surface of enterprise network 110. Mapping module 276 may translate information received from external data sources 108 into a form that specifically pertains to enterprise network 110. Mapping module 276 may modify data within threat registry 272 to align with the specifics of enterprise network 110. Mapping module 276 may store information within threat registry 272 in such a way that enables threat management system 260 to respond to queries for information about threats specifically or alternatively, about various aspects of enterprise network 110.

Analysis module 277 may perform functions relating to assessing to what extent that enterprise network 110 is exposed to various security threats. Analysis module 277 may evaluate various threats (accessed in threat registry 272 and described through threat information 273) and determine to what extent that such threats may apply to the attack surface of enterprise network 110. Analysis module 277 may, for each such threat, generate a risk score that indicates a level of exposure to that threat by enterprise network 110. Although analysis module 277 may be described in connection with FIG. 2 as performing analysis of various threats to calculate a risk score, analysis module 277 may alternatively, or in addition, perform other operations. Functions performed by analysis module 277 could be performed by a hardware device or one implemented primarily or partially through hardware. In other examples, functions performed by general module 222 could be performed by software or by a hardware device executing software.

Testing module 278 may perform functions relating to evaluating the effectiveness of security controls included within enterprise network 110. In some examples, testing module 278 of threat management system 260 may cause communication unit 265 to output one or more exploratory signals to test or evaluate systems associated with network 140, such as security controls 114, 124, 134, and/or 146. Testing module 278 may store information about how the exploratory signals were processed within threat registry 272.

In accordance with one or more aspects of the present disclosure, threat management system 260 may discover information about enterprise network 110. For instance, in an example that can be described with reference to FIG. 2, network discovery module 274 of threat management system 260 causes communication unit 265 to output a signal over one or more networks within enterprise network 110. One or more network devices and/or systems within enterprise network 110 detect the signal and interpret the signal as a request for information. Each of such devices respond to the signal with information about the structure of enterprise network 110 and devices and systems included within enterprise network 110. Accordingly, network discovery module 274 effectively performs network discovery operations, and discovers, enumerates, and profiles about assets, systems, network structure, and other information about enterprise network 110. Although described and illustrated as a single module within threat management system 260, network discovery module 274 may be distributed across multiple systems within enterprise network 110. In other examples, network discovery module 274 may engage other network discovery tools or data collection agents deployed within enterprise network 110 to perform network discovery operations, and to collect information about enterprise network 110.

Threat management system 260 may store information discovered about enterprise network 110. For instance, continuing with the example being described with reference to FIG. 2, network discovery module 274 of threat management system 260 collects and ingests information it receives as a result of performing network discovery operation (or engaging other systems to perform network discovery operations). Through similar techniques, network discovery module 274 may also ingest and store configuration data for enterprise network 110 and any data stored in any configuration management databases associated with enterprise network 110. Network discovery module 274 stores the information collected in data store 275. Information collected by network discovery module 274 such information may include information about security controls in place on enterprise network 110, how such controls are configured, and other information about such controls. Network discovery module 274 of threat management system 260 uses the collected information to assemble data structures, models of enterprise network 110, and/or information describing attributes of an attack surface associated with enterprise network 110. Network discovery module 274 may store such data structures, models, and attack surface information within data store 275.

Threat management system 260 may collect threat information from external systems. For instance, still referring to FIG. 2, data sources module 271 of threat management system 260 causes communication unit 265 to output a signal over network 101. One or more of external data sources 108 detect a signal and determine that the signal corresponds to a request for information about security threats and detecting security threats to computing systems, networks, and related systems. Each of external data sources 108 respond to the signal by outputting information over network 101. Communication unit 265 of threat management system 260 detects a series of signals and outputs information about the signals to data sources module 271. Data sources module 271 determines that the signals include information responding to the request for information relating to security threats. In some examples, such information may correspond to information based on the MITRE ATT&ACK framework or the National Vulnerability Database developed by NIST, as described above. Such information may include data derived from other sources as well. Data sources module 271 stores information derived from various external data sources 108 within threat registry 272.

Threat management system 260 may correlate the data received from different data sources. For instance, referring again to FIG. 2, data sources module 271 analyzes the collected data and determines that various sets of collected data have different formats and different content. Data sources module 271 further determines, however, that although the data may have originated from different external data sources 108, one or more sets of data have certain common or related fields. Data sources module 271 uses these common or related fields to correlate disparate and diverse data from multiple sources, and stores the data in a structured and/or normalized way that enables queries to be performed across multiple data sets. In some examples, data sources module 271 may engage and use open source libraries that enable or assist in the correlation of diverse data sources. In other examples, data sources module 271 may generate a user interface that may be presented to an administrator or other user, enabling some degree of manual linking of data across multiple data sources. Data sources module 271 generates organized and structured information about specific threats, threat vectors, compensating controls, tactics, techniques, and/or procedures and stores such information within threat registry 272. As a result, threat registry 272 includes information describing various threats (each described by an instance of threat information 273) that may affect enterprise network 110.

Threat management system 260 may map threat information to enterprise network 110. For instance, referring again to FIG. 2, mapping module 276 accesses data within both threat registry 272 and data store 275. Mapping module 276 identifies various instances of threat information and determines how each such threat corresponds to enterprise network 110 or the attack surface associated with enterprise network 110. Mapping module 276 may translate data collected from external sources and/or stored within threat registry 272 to align with the needs or the specific attack surface relevant to enterprise network 110. Such translations may involve mapping module 276 modifying data within threat registry 272 to facilitate later retrieval of data based on topic or subject, or based on a specific aspect or system included within enterprise network 110. Mapping module 276 may store structured data within threat registry 272 in a way that enables threat management system 260 to respond to queries for information about a specific type of threat with information derived from any or all of external data sources 108 or from other sources.

Threat management system 260 may proactively perform an assessment using both information about the attack surface associated with enterprise network 110 and threat information stored within threat registry 272. For instance, continuing with the example being described in the context of FIG. 2, analysis module 277 of threat management system 260 queries threat registry 272 to identify a potential threat for evaluation. Threat registry 272 responds to the query by identifying a specific threat (described by a specific instance threat information 273). Analysis module 277 analyzes this specific instance of threat information 273 to determine information about systems within enterprise network 110 or aspects of enterprise network 110 that may be impacted or affected by the identified threat. Analysis module 277 may interact with mapping module 276 in performing such an analysis. In one specific example, analysis module 277 determines that the specific threat identified by threat information 273 affects or is relevant to network 140 of enterprise network 110 and each of enterprise systems 142 that are connected to network 140 within enterprise network 110.

Threat management system 260 may determine how to evaluate whether network 140 within 110 is protected against the threat described by threat information 273. For instance, still referring to the example being described with reference to FIG. 2, analysis module 277 of threat management system 260 identifies, based on threat information 273, information about enterprise network 110 and 140 that is relevant to the identified threat. In some examples, threat information 273 may describe various tactics and/or techniques that are used to perpetrate the threat described by threat information 273. Analysis module 277 determines, based on threat information 273, one or more security controls that, according to known intelligence about the threat (e.g., derived from the MITRE ATT&CK framework), should be in place within enterprise network 110 to counteract the threat described by threat information 273. In some examples, analysis module 277 may also determine, based on research performed by teams tasked with defending enterprise network 110, various countermeasures that may be effective in counteracting the threat described by threat information 273.

Threat management system 260 may evaluate whether the recommended security controls or countermeasures exist and are operating within enterprise network 110. For instance, referring again to FIG. 2, analysis module 277 of threat management system 260 evaluates whether the security controls identified as potentially effective to combat the threat described by threat information 273 are present within enterprise network 110. If present, analysis module 277 evaluates the effectiveness of such controls. To evaluate the effectiveness of such controls, analysis module 277 may determine, for example, whether the controls are actually operating or performing the desired function. In some examples, analysis module 277 may consult enterprise network log 111, which may serve as a repository of information reported by various systems, devices, controls, and other aspects of enterprise network 110. Analysis module 277 may evaluate information stored within enterprise network log 111 to determine whether the relevant controls are logging or reporting information, which may indicate whether and to what extent such controls are operating. Based on enterprise network log 111, analysis module 277 may therefore determine which of the relevant controls are operating. For example, in FIG. 2, analysis module 277 may determine that security control 144 is operating as a firewall associated with network 140, and is logging information about its operation within enterprise network log 111.

Threat management system 260 may evaluate the effectiveness of the security controls based on logged information. For instance, continuing with the example being described, analysis module 277 may further evaluate information logged within enterprise network log 111 about actions that have been taken by such controls to address security or other issues that have arisen within enterprise network 110. Based on this further evaluation, analysis module 277 may be able to assess how effective such controls have been in defending enterprise network 110 and/or network 140 specifically. In such examples, the effectiveness of various controls can be evaluated to at least to some extent by observing the historical operation of the control, as indicated by information the control may store within enterprise network log 111. In the example of FIG. 2, analysis module 277 may determine, based on enterprise network log 111, that security control 144 (e.g., a firewall) has recently blocked various attempts to access network 140 over network 101.

Threat management system 260 may also proactively evaluate the effectiveness of the security controls. For instance, in some examples, testing module 278 of threat management system 260 may cause communication unit 265 to output one or more exploratory signals over enterprise network 110 (from within enterprise network 110), or over network 101 (e.g., by engaging threat management system 260E). Systems associated with network 140 may detect such exploratory signals and respond in some way. In the example being described, security control 144 may detect the exploratory signals and log information (e.g., within enterprise network log 111) about how security control 144 responded to the signal; systems and devices on network 140 may similarly detect such signals and log information. Alternatively or in addition, testing module 278 of threat management system 260 may interact directly with security control 114 and/or network 140 to determine further information about how and the extent to which security control 114 and network 140 processed the exploratory signals. Testing module 278 may store information about how the exploratory signals were processed within threat registry 272, and such information may be used (e.g., by analysis module 277) to evaluate the effectiveness of the defenses in place to counteract the threat described by threat information 273. As further described herein, such an evaluation may result in a score (or a factor in computing a score) associated with the threat described by threat information 273.

Preferably, evaluations performed by testing module 278 are based on quantitative data or testing results that are amenable to processing pursuant to a quantitative analysis. An analysis that is based on quantitative data (e.g., as opposed to an analysis based on subjective data, such as human-generated data, survey results, or training) has a number of advantages, including greater reliability, consistency, and susceptibility to effective presentation in a report (e.g., as a graph or chart). Quantitative analyses may, in general, also offer a better ability to automatically evaluate effects of changes to enterprise network 110 over time, or changes to the level of security or defense readiness of enterprise network 110 over time.

Threat management system 260 may evaluate other factors relevant to the threat described by threat information 273, including other vulnerabilities implicated by the threat described by threat information 273. For instance, continuing with the example being described with reference to FIG. 2, analysis module 277 accesses information about enterprise network 110 in data store 275. Analysis module 277 assesses, based on information stored within data store 275, vulnerabilities of network 140 implicated by the threat described by threat information 273. Analysis module 277 determines, for example, whether network 140 has any specific attributes that make network 140 and/or enterprise systems 142 more or less vulnerable than other systems within enterprise network 110. In some examples, network 140 and/or enterprise systems 142 may use specific network devices or software subsystems that have known security weaknesses that, if unauthorized access to network 140 is obtained, could further threaten enterprise network 110.

Threat management system 260 may evaluate the business importance or the financial value associated with data maintained by systems affected by the threat described by threat information 273. For instance, continuing with the example being described, threat management system 260 may determine whether the information processed or stored on network 140 (e.g., by enterprise systems 142) is highly secretive, or has a significant financial value. For instance, if enterprise systems 142 operate as high dollar payment systems, threats to enterprise systems 142 are a greater risk than threats to systems that merely provide information for presentation by an informational website.

Threat management system 260 may also evaluate how the connectedness of network 140 affects the risk of the threat described by threat information 273. For instance, still continuing with the example being described with reference to FIG. 2, analysis module 277 accesses data store 275 to identify systems connected to network 140. Analysis module 277 determines that although the threat described by threat information 273 is primarily directed to network 140, network 140 is also connected in various ways to other networks and systems within enterprise network 110. For example, in FIG. 2, one of enterprise systems 142 is directly connected to one of enterprise systems 132 on network 130. Accordingly, vulnerabilities of network 130 and/or enterprise systems 132 may be relevant to the threat described by the threat being evaluated, since a security threat that impacts network 140 and enterprise systems 142 may also impact one or more of enterprise systems 132 or network 130, given the connection between enterprise systems 142 and enterprise systems 132. Analysis module 277 performs an evaluation of each system that has some connection to network 140, since such systems may also be potentially affected by the threat described by threat information 273. Analysis module 277 assesses, for each of the systems connected to network 140, the vulnerabilities, business importance, and/or financial value associated with such systems.

Threat management system 260 may generate a risk score associated with the threat being evaluated. For instance, still continuing with the example being described in the context of FIG. 2, analysis module 277 performs calculations to generate a score that represents the significance of the risk and/or threat described by threat information 273, as applied to enterprise network 110. To perform such calculations, analysis module 277 considers whether relevant controls are in place to counteract the threat described by threat information 273 as well as any information about the effectiveness of such controls. Analysis module 277 determines that the risk score is higher if controls are missing or ineffective, and lower if controls are in place and are effective. Analysis module 277 also considers the vulnerabilities of the systems within enterprise network 110 that are principally affected by the threat, and their relative importance from a business, financial, or other point of view. Analysis module 277 also considers the vulnerabilities of the systems connected to those that are principally affected by the threat, and their relative importance from a business, financial, or other point of view. Analysis module 277 determines that the risk score is higher if the affected systems have significant vulnerabilities and/or are relatively important. Analysis module 277 determines that the risk score associated with the threat being evaluated is lower if the systems affected do not have significant vulnerabilities and/or are not considered as being of high importance from a business, financial, or other perspective (e.g., informational systems or systems that do not handle financial data). Based on these and other factors, analysis module 277 generates a risk score.

Threat management system 260 may output information about the calculated risk score. For instance, again referring to FIG. 2, analysis module 277 generates information sufficient to present a user interface. Analysis module 277 causes communication unit 265 to output a signal over network 101. Administrator device 105 detects a signal over network 101 and determines that the signal includes information sufficient to present a user interface. Administrator device 105 uses the information to present a user interface at a display associated with administrator device 105. In some examples, the user interface presents the calculated risk score in the form of a report, an alert, or a dashboard to be viewed by administrator 104.

In the example described, analysis module 277 performs an analysis of the threat described by threat information 273 proactively, and not necessarily in response to any specific activity on enterprise network 110, any attempted attack on enterprise network 110, or any user input. Instead, analysis module 277 may perform the described analysis as part of an ongoing, proactive process of monitoring defenses that enterprise network 110 may have in place to counter various threats to enterprise network 110, whether known or unknown.

Threat management system 260 may periodically, occasionally, or continually perform additional proactive assessments. For instance, referring again to FIG. 2, analysis module 277 may query threat registry 272 to a identify a different threat that may impact enterprise network 110. Once a different threat is identified (i.e., based on a different instance of threat information 273 derived from threat registry 272), analysis module 277 may calculate a risk score associated with the threat. In some examples, analysis module 277 evaluates a number of threats simultaneously, or alternatively, may evaluate threats one at a time. For each threat, analysis module 277 may calculate a risk score for presentation as an alert, a report, or for inclusion within a dashboard in a manner similar to that described above. In some examples, analysis module 277 may continually perform assessments of many different threats included within threat registry 272. In other examples, threat registry 272 might only occasionally or periodically perform such assessments, at appropriate times, such as during periods of relatively low utilization of enterprise network 110 or low utilization of specific networks and systems within enterprise network 110. In some examples, analysis module 277 might only report risk scores that meet a threshold for evaluation by an administrator or other risk personnel.

In addition to assessing threats derived from information gleaned from external data sources 108, threat management system 260 may assess additional threats from other sources. For instance, teams working within or on behalf of enterprise network 110 (e.g., so-called “red teams”) may occasionally or continually evaluate systems, software, bugs, and policies in place within enterprise network 110 to identify potential vulnerabilities or issues that are or could lead to a threat to enterprise network 110. Such teams may research reports of threats perpetrated against other networks, and may determine how such threats might be applied to architectures, platforms, assets, systems within enterprise network 110. Such teams may also engage in active attempts to simulate attacks or discover ways in which enterprise network 110 might vulnerable to a threat (e.g., so-called “ethical hacking” activities). Such efforts may uncover attack techniques that were previously unknown, and not addressed or illuminated by external data sources 108. Information based on such activities may be used to augment or update threat registry 272, resulting in additional instances of threat information 273. Once such information about these new threats is stored within threat registry 272, analysis module 277 may thereafter periodically and proactively assess enterprise network 110 with respect to such threats.

Analysis module 277 may perform various analyses proactively by evaluating threats within a portfolio of threats in an automated way, and collecting data about new threats and changes to enterprise network 110 over time. By incrementally collecting information about new threats, analysis module 277 may automatically evaluate how such new threats affect enterprise network 110 as well as evolving attributes of enterprise network 110. Such a process may enable management and proactive assessment of threats to enterprise network 110 at scale, enabling the processing of a continual stream of new data about existing and new threats in the context of an ever-evolving state and configuration of enterprise network 110. Analysis module 277 may process such a stream of data to calculate risk scores over time. Such risk scores may enable evaluation of threat trends as well as specific information about threats to be countered.

Threat management system 260 may also perform assessments in response to a user query about a specific threat. For instance, referring again to FIG. 2, administrator device 105 detects input that it determines corresponds to a request to interact with threat management system 260. Administrator device 105 outputs a signal over network 101. Communication unit 265 of threat management system 260 detects a signal and outputs information about the signal to analysis module 277. Analysis module 277 determines that the signal corresponds to a request, by a user of administrator device 105, to calculate a risk score for a specific threat. Analysis module 277 accesses threat registry 272 for information about the threat. Analysis module 277 performs an assessment by identifying aspects of the attack surface of enterprise network 110 that may be affected by the threat. Analysis module 277 identifies relevant networks and systems, and assesses the defenses in place within enterprise network 110 to counteract the threat. Analysis module 277 may evaluate the connectedness, vulnerabilities, and business and financial importance of the affected system. Based on this information, analysis module 277 generates a risk score associated with the threat. Analysis module 277 causes communication unit 265 to output a signal over network 101. Administrator device 105 detects a signal and determines that the signal corresponds to a response to the earlier request. Administrator device 105 presents a user interface that includes information (e.g., a risk score) indicating the extent to which enterprise network 110 is protected against the identified threat. In some examples, the user interface includes the calculated risk score and any other information pertinent to the threat.

In a similar manner, threat management system 260 may perform assessments in response to a user query about a specific aspect of enterprise network 110. For instance, in another example that can be described in the context of FIG. 2, administrator device 105 detects input and outputs a signal over network 101. Communication unit 265 of threat management system 260 detects the signal and analysis module 277 determines that the signal corresponds to a request for an assessment about a specific aspect of enterprise network 110, such as a specific network, subsystem, server, application, application system, or service. Analysis module 277 performs an assessment for the requested aspect of enterprise network 110. Analysis module 277 causes communication unit 265 to output information over network 101. Administrator device 105 detects a signal over network 101 that it determines corresponds to a response to the earlier request for an assessment about a specific aspect of enterprise network 110. Administrator device 105 uses information included in the signal to present a user interface that presents information about threats that might apply to the identified aspect or portion of enterprise network 110.

The ability to query threat registry 272 for information about specific aspects of enterprise network 110 may provide significant benefits. In some examples, information within threat registry 272 might be structured to enable analysis of the resiliency of enterprise network 110. An administrator might query threat registry 272 to determine various dependencies (e.g., horizontal dependencies) that might not otherwise be apparent, even to those with significant knowledge of enterprise network 110. For instance, for a particular threat that affects a specific portion of enterprise network 110, a query pertaining to that threat might highlight specific controls within enterprise network 110 that are relied upon to defend against such a threat. A further query of threat registry 272 requesting information about any effects that might result from removing such controls could reveal further vulnerabilities of enterprise network 110 that might flow from such a threat, if such controls are removed. Conversely, a query of threat registry 272 requesting information about effects that might result from adding certain controls could also reveal further vulnerabilities (or reductions in risk) that might result from adding such controls. Queries of this nature might pertain to controls, as described, but such queries might also pertain to network policies, applications, network devices, or other aspects of systems, subsystems, or processes in place within enterprise network 110.

In general, such queries may be used to assess security threats to enterprise network 110, but such queries might also be used for other purposes. For example, if dependencies of a particular application, network subsystem, or other aspect of enterprise network 110 can be isolated and identified, it may be possible to assess effects that might result from continuing or terminating business operations performed by an enterprise in a particular region of the world or a particular country. Similarly, the impact of divesting a particular line of business might also be helpfully assessed by analyzing the effects of removing portions of enterprise network 110 that pertain to that line of business. Similarly, it might be possible to consider and evaluate the effect of moving into new lines of business or acquiring an existing business having operations that could be folded into enterprise network 110. Essentially, if threat registry 272 is configured with sufficient information about enterprise network 110 and various dependencies and capabilities of systems within enterprise network 110, threat registry 272 may enable creation of a universal research agent, capable of assessing a variety of aspects of an organization that enterprise network 110 supports, beyond mere assessments of threats to enterprise network 110.

Modules illustrated in FIG. 2 (e.g., data sources module 271, data store 275, mapping module 276, and analysis module 277) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

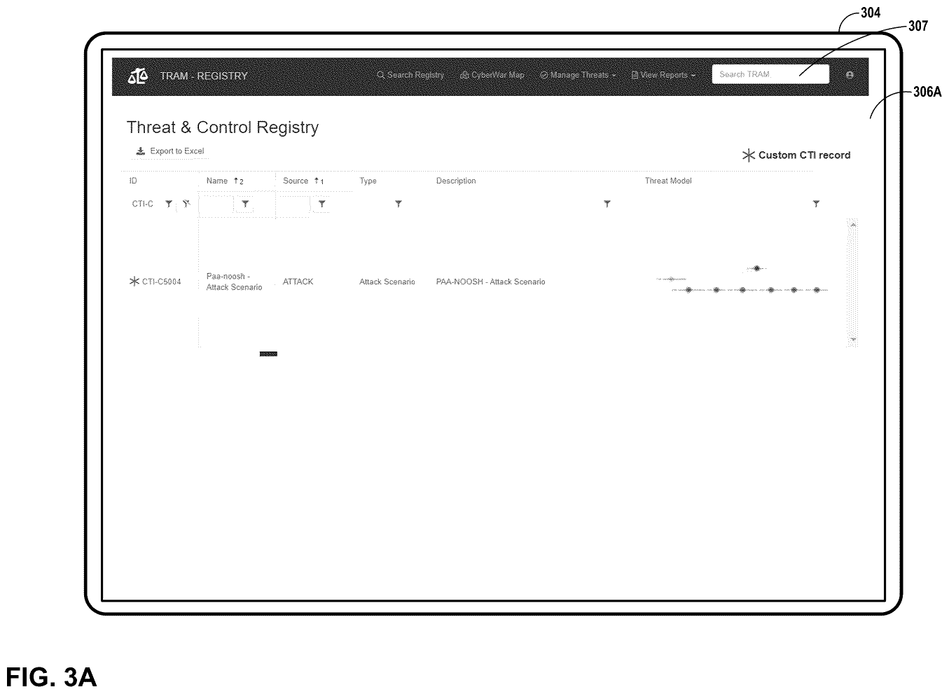

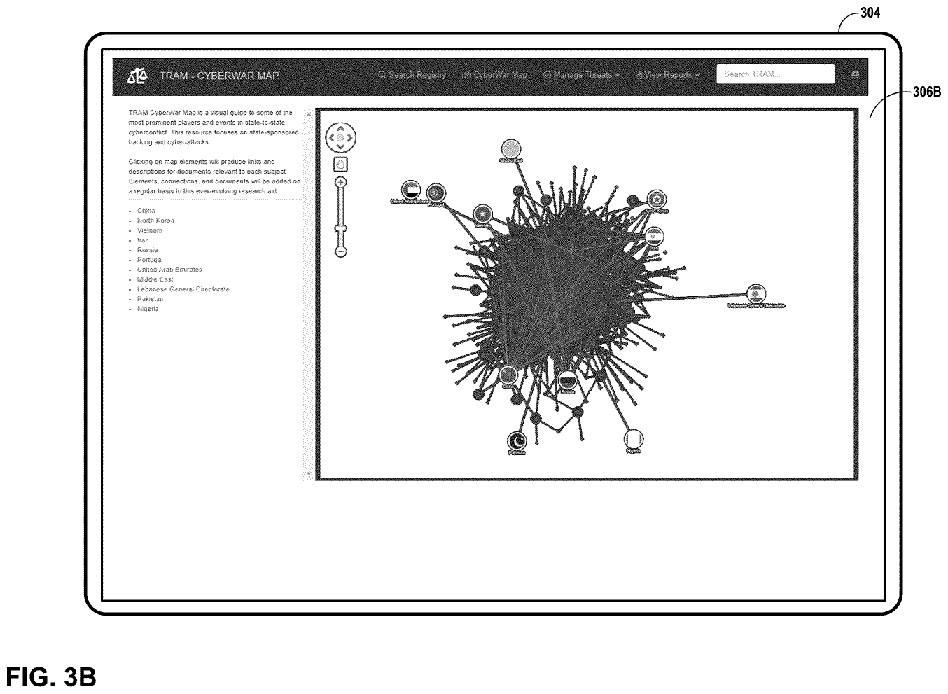

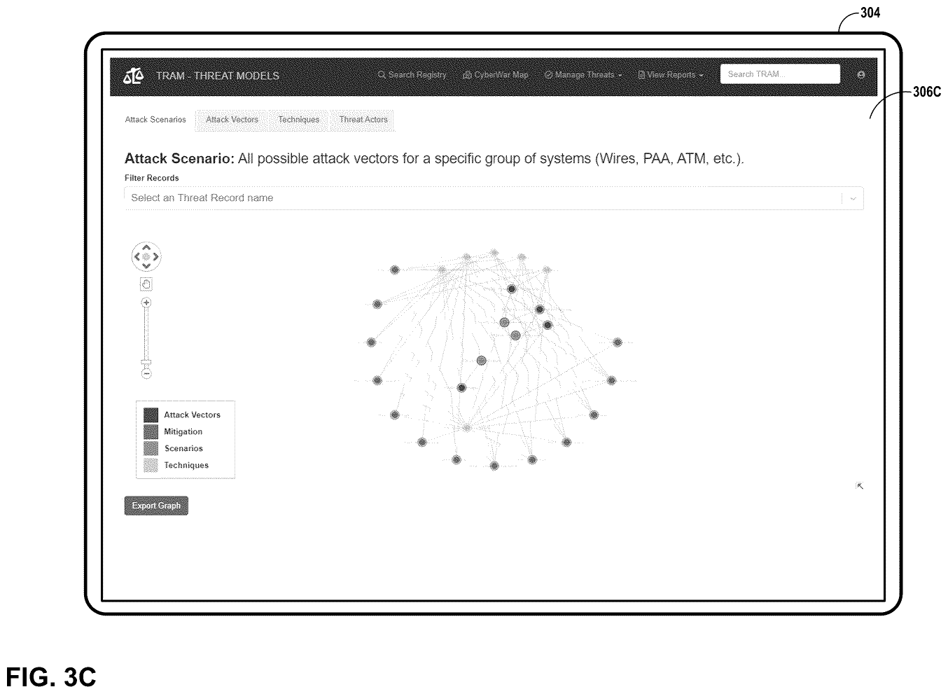

FIG. 3A, FIG. 3B, and FIG. 3C are conceptual diagrams illustrating example user interfaces presented by a user interface device in accordance with one or more aspects of the present disclosure. Each of FIG. 3A, FIG. 3B, and FIG. 3C illustrate user interfaces 306A, 306B, and 306C, respectively. Each such user interface may be presented at display device 304 by a computing system, such as administrator device 105 of FIG. 1A or FIG. 2.

Although the user interfaces illustrated in FIG. 3A, FIG. 3B, and FIG. 3C are shown as graphical user interfaces, other types of interfaces may be presented in other examples, including a text-based user interface, a console or command-based user interface, a voice prompt user interface, or any other appropriate user interface. One or more aspects of the user interfaces illustrated in FIG. 3A, FIG. 3B, and FIG. 3C may be described herein within the context of administrator device 105 and threat management system 260 of FIG. 2.

FIG. 3A illustrates an example user interface that presents entries from an example threat registry. In the example of FIG. 3A, user interface 306A presents one or more rows, each corresponding to a different threat (e.g., an instance of threat information 273 from threat registry 272). Threats derived from threat registry 272 may be presented in a table format, with a row associated with each threat. In the example shown in user interface 306A, columns in the table correspond to an identification code, name, source, type, and description associated with each threat illustrated in a row of the table. One or more of the columns may also present a graphical model for each threat (i.e., see the column labeled “Threat Model”). Search box 307 enables a user (e.g., administrator 104 operating administrator device 105) to query threat registry 272 in one or more of the ways described above in connection with FIG. 2.

FIG. 3B illustrates an example user interface that presents a so-called “cyberwar” map. In the example of FIG. 3B, user interface 306B illustrates a graphical map of threats that may apply to various geographical locations spanned by enterprise network 110. The map illustrated in FIG. 3B may serve as a visual guide to prominent players and events in state-to-state cyberconflicts, such as those pertaining to state-sponsored hacking and cyber-attacks. In the example shown, user interactions with map elements (e.g., a mouse click) may produce links and descriptions for documents relevant to each subject. Such information, which may include elements, connections and documents, may be updated regularly and serve as an ever-evolving research aid.

FIG. 3C illustrates an example user interface that presents a graphical illustration of an attack scenario. User interface 306C presents a graph of various attack vectors, mitigations, scenarios, and techniques that may pertain to a specific threat to which enterprise network 110 may be exposed. User interface 306C enables interactions with the illustrated graph to show dependencies between one or more of the nodes presented within the graph.

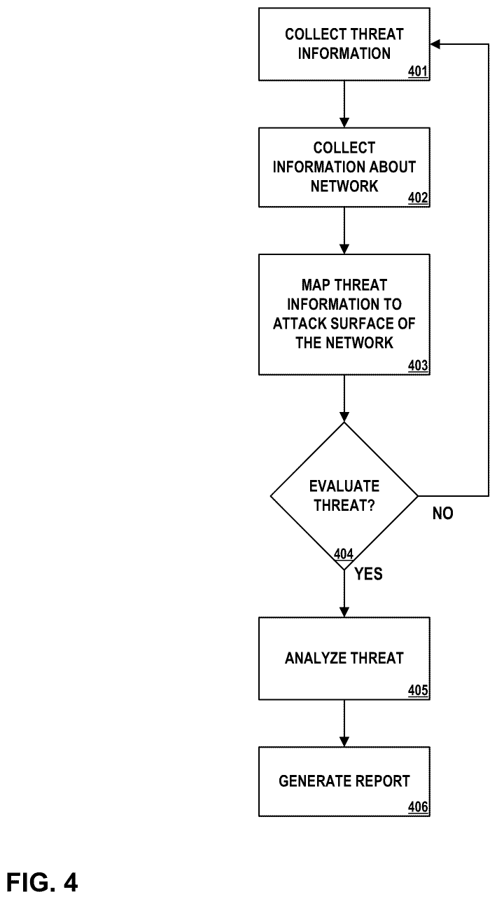

FIG. 4 is a flow diagram illustrating operations performed by an example threat management system in accordance with one or more aspects of the present disclosure. FIG. 4 is described below within the context of threat management system 160 of FIG. 1A. In other examples, operations described in FIG. 4 may be performed by one or more other components, modules, systems, or devices. Further, in other examples, operations described in connection with FIG. 4 may be merged, performed in a difference sequence, omitted, or may encompass additional operations not specifically illustrated or described.

In the process illustrated in FIG. 4, and in accordance with one or more aspects of the present disclosure, threat management system 160 of FIG. 1A may collect threat information (401). For example, with reference to FIG. 1A, threat management system 160 interacts with one or more of external data sources 108 to identify and acquire information about threats that may apply to enterprise network 110. Threat management system 160 stores the information derived from the collected information within registry 172.

Threat management system 160 may collect information about enterprise network 110 (402). For example, again referring to FIG. 1A, threat management system 160 engages in network discovery operations to enumerate and profile information assets, systems, and networks, and other information associated with enterprise network 110. In some examples, threat management system 160 may engage other systems within enterprise network 110 (e.g., network agents) to perform some or all of such network discovery operations.

Threat management system 160 may map threat information to the attack surface of enterprise network 110 (403). For example, in FIG. 1A, threat management system 160 translates the information derived from external data sources 108 (and stored in registry 172) into a form that applies to enterprise network 110. To the extent that registry 172 identifies specific security controls that are applicable to a given threat, threat management system 160 interprets such information and determines which corresponding security controls should be used by or employed within enterprise network 110.

Threat management system 160 may determine whether to analyze a prospective threat (YES path from 404). In some examples, threat management system 160 may proactively and continuously evaluate a series of threats enumerated within registry 172. In such an example, threat management system 160 may operate continually or near-continually in an automated and proactive fashion, and might not need user input to authorize the analysis of the threat (YES path from 404). In other examples, threat management system 160 may prompt a user for a threat or specific system within enterprise network 110 to analyze, and might refrain from performing threat analysis until commanded to do so (NO path from 404).

Threat management system 160 may analyze a threat (405). For example, in FIG. 1A, threat management system 160 identifies the systems that may be affected by a given threat, and analyzes to what extent enterprise network 110 may be vulnerable to such a threat. In performing the analysis, threat management system 160 may determine whether appropriate security controls are in place within enterprise network 110 to counter the threat, and if so, how effective such security controls are. Threat management system 160 may, for each threat analyzed, generate a risk score that represents the results of its assessment.

Threat management system 160 may generate a report (406). For example, in FIG. 1A, threat management system 160 may output, to administrator device 105, information sufficient to present a user interface. Administrator device 105 may receive the information and use the information to generate user interface 106. In some examples, user interface 106 may present information about the analysis performed by user interface 106 (e.g., present information about the calculated risk score).

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

For ease of illustration, only a limited number of devices (e.g., networks 101, devices 103, administrator devices 105, external data sources 108, enterprise networks 110, threat management system 160, threat management system 260, as well as others) are shown within illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated in the Figures herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

Certain techniques described in this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

1. A method comprising:
collecting, by a computing system and from a plurality of data sources, threat information about a plurality of threats;
storing, by the computing system and in a threat registry, the threat information;
collecting, by the computing system, information about an attack surface for an enterprise network;
mapping, by the computing system, the threat information to the attack surface; and
proactively calculating, by the computing system and based on the mapping of the threat information to the attack surface, a risk score associated with a specific threat in the plurality of threats, wherein the risk score represents a vulnerability assessment of the enterprise network to the specific threat, and wherein proactively calculating the risk score includes:
identifying a network system to which the specific threat pertains,
evaluating business and financial importance of the network system,
determining whether a security control that counteracts the specific threat is operating, wherein the security control is within the enterprise network,
determining effectiveness of the security control by interacting with the security control, wherein interacting with the security control includes outputting exploratory signals to simulate an attack and evaluate how the security control processed the exploratory signals,
identifying systems that are connected to the network system, and
evaluating business and financial importance of the systems that are connected to the network system.

2. (canceled)

3. (canceled)

4. The method of claim 1, wherein proactively calculating the risk score includes:
proactively analyzing each of the plurality of threats.

5. The method of claim 4, wherein proactively analyzing each of the plurality of threats includes:
identifying a respective risk score for each of the plurality of threats, wherein the respective risk scores represent an assessment of the vulnerability of the enterprise network to each respective threat in the plurality of threats.

6. The method of claim 1, further comprising:
detecting input requesting an analysis of a user-identified threat; and
responsive to the input, analyzing the user-identified threat.

7. (canceled)

8. (canceled)

9. (canceled)

10. The method of claim 1, wherein collecting threat information includes:
collecting threat information derived from research performed by a red team based on an analysis of the enterprise network.

11. The method of claim 1, wherein collecting threat information includes:
collecting threat information derived from observations made by users of the enterprise network.

12. The method of claim 1, wherein collecting threat information includes:
collecting structured threat information from external data sources, where the structured threat information is maintained using standardized practices and methodologies.

13. The method of claim 12, wherein the threat information is based on the MITRE ATT&CK framework.

14. The method of claim 1, wherein storing the threat information includes:
correlating structured data from each of the plurality of data sources.

15. The method of claim 14, wherein storing the threat information further includes:
storing the correlated structured data to enable queries across multiple sets of data that are derived from the plurality of data sources.

16. The method of claim 1, wherein mapping the threat information to the attack surface includes:
translating the threat information to attributes of the enterprise network.

17. A system comprising:
a storage system; and
processing circuitry having access to the storage system and configured to:
collect threat information about a plurality of threats,
store, in a threat registry, the threat information,
collect information about an attack surface for an enterprise network,
map the threat information to the attack surface, and
proactively calculate, based on the mapping of the threat information to the attack surface, a risk score associated with a specific threat in the plurality of threats, wherein the risk score represents a vulnerability assessment of the enterprise network to the specific threat, and
wherein to proactively calculate the risk score, the processing circuitry is configured to:
identify a network system to which the specific threat pertains,
evaluate business and financial importance of the network system,
determine whether a security control that counteracts the specific threat is operating, wherein the security control is within the enterprise network,
determine effectiveness of the security control by interacting with the security control, wherein interacting with the security control includes outputting exploratory signals to simulate an attack and evaluate how the security control processed the exploratory signals,
identify systems that are connected to the network system, and
evaluate business and financial importance of the systems that are connected to the network system.

18. (canceled)

19. (canceled)

20. A non-transitory computer-readable storage medium comprising instructions that, when executed, configure processing circuitry of a computing system to:
collect threat information about a plurality of threats;
store, in a threat registry, the threat information;
collect information about an attack surface for an enterprise network;
map the threat information to the attack surface; and
proactively calculate, based on the mapping of the threat information to the attack surface, a risk score associated with a specific threat in the plurality of threats, wherein the risk score represents a vulnerability assessment of the enterprise network to the specific threat, and wherein to proactively calculate the risk score, the processing circuitry is further configured to:
identify a network system to which the specific threat pertains,
evaluate business and financial importance of the network system,
determine whether a security control that counteracts the specific threat is operating, wherein the security control is within the enterprise network,
determine effectiveness of the security control by interacting with the security control, wherein interacting with the security control includes outputting exploratory signals to simulate an attack and evaluate how the security control processed the exploratory signals,
identify systems that are connected to the network system, and
evaluate business and financial importance of the systems that are connected to the network system.
